(19) United States
(12) Patent Application Publication
(10) Pub. No.: US 2002/0023381 A1
(43) Pub. Date: Feb. 28, 2002

(54) Retaining device for fishing accessory container

(76) Inventor: Neil James Chambeyron, Wodonga (AU)

Correspondence Address: Rocco S. Barrese, Esq., Dilworth & Barrese, LLP, 333 Earle Ovington Blvd, Uniondal, NY, 11553, US

(21) Appl. No.: 09/800,345

(22) Filed: Mar. 5, 2001

(30) Foreign Application Priority Data
Mar. 3, 2000 (AU) PQ5998

(51) Int. Cl. A01K 97/00; A01K 97/04

(52) U.S. Cl. 43/54.1

(57) ABSTRACT

A retaining device (2) for attachment to a fishing accessories container (20) adapted to releasably retain one or more fishing rods (13) or other accessories, such as a torch (28). The device (2) has a first member (4) pivotally attached to a second member (6) which in turn is connected to the lid (22) of the container (20). Either or both of the members have a plurality of spaced apart recesses (10, 12, 14, 16) and the first member (4) is configured for movement to create an opening between it and the second member (6) to allow the fishing rods (13) or accessories (28) to be inserted into or removed from the recesses. There is also disclosed a fishing accessories container (20) having a handle means (30) which may also be used for keeping a user buoyant in situations where a user is submerged in water. A detachable strap (35) may be attached to an ankle of the user to assist in keeping the user buoyant.

### FIELD OF THE INVENTION

The present invention relates to a retaining device for a fishing accessory container, and more specifically to a retaining device for attachment to a fishing tackle box that enables a fishing person to carry all the accessories required for fishing in or on one convenient box. Furthermore the fishing accessories container provides facilities for using accessories when fishing at night and also incorporates a safety device in situations where fishing people find themselves in danger of drowning as a result of being swept off rocks and the like due to rough seas and adverse weather conditions.

### BACKGROUND OF THE INVENTION

Fishing generally requires a lot of accessories, such as fishing rods, tackle, bait, lures, knives, nets and food and beverage which takes a lot of time to initially set up when a fishing location has been selected. Often the case is that the fishing person has to do many trips in carrying all of the equipment and accessories from, for example, a car or their house which is generally inconvenient and wastes a lot of time. Furthermore the fishing person, when carrying these items on individual trips will not have at least one hand free for carrying extra items or for any other particular use. Furthermore, often better results are achieved by fishing people at night time and when carrying all the fishing equipment and accessories the same problem arises where a fishing person would generally not have one hand free to at least hold a torch or some illumination device to see where they are going and what they are doing.

Another problem faced by fishing persons is when fishing off rocks or otherwise very close to a coast line. Freak waves sometimes occur that sweep fishing people off the rocks into the water below thereby making them susceptible to drowning. Often fishing persons do not carry life jackets or other buoyancy devices that in such situations would allow them to at least stay afloat which can be vital particularly in severe weather conditions.

The present invention seeks to overcome one or more of the above disadvantages by providing a fishing accessory container that enables a fishing person to carry all of their equipment and accessories either in one hand or over their shoulder and provides a convenient way of storing or holding an illumination device, such as a torch, for fishing at night time and also the container has properties whereby if a fishing person is swept off rocks into sea the fishing container will generally be attached to the person and act an a buoyancy device when they are in the water.

### SUMMARY OF THE INVENTION

According to a first aspect of the invention there is provided a retaining device for attachment to a fishing accessories container, said retaining device adapted to releasably retain one or more fishing rods and/or other accessories, said retaining device comprising:

a pair of members pivotally attached at one end thereof, one member of said pair of members being attached to said container;

one or both of said members having a plurality of spaced apart recesses extending from one side to a further opposite side of said member in said pair of members;

wherein the other of said pair of members is configured for movement to create an opening between said pair of members so as to allow insertion to or removal from said plurality of recesses, said one or more fishing rods and/or accessories.

The apertures may be of varying sizes to accommodate varying widths or diameters of said fishing rods and/or accessories. The plurality of apertures may each be defined by a portion that protrudes into said one member and a portion that protrudes into said other member of said pair of members. Located at a distal end of said other member may be a securing means for locking the other member to the container.

The fishing accessories container may additionally have a means for holding an illumination device, such as a torch, said means constituted by a substantially cylindrical receptacle into which is placed the torch. The holding means may be attached to the container by suitable securing means, such as brackets. In this way the holding means may double up as a handle by which a user can carry the container. Alternatively the illumination means may fit into a respective aperture of the said retaining device.

According to a second aspect of the invention there is provided a fishing accessories container for storing accessories required by a user, said container comprising:

a base portion;

a lid portion hingedly connected to said base portion wherein said lid portion is adapted for movement to allow access to the interior of the container;

handle means constituted by a substantially hollow member adapted for carrying an illumination means;

such that when said illumination means is enabled or switched on it allows a user to easily see where they travel in dark conditions whilst carrying the container in one hand.

According to a third aspect of the invention there is provided a fishing accessories container for storing accessories required by a user, said container being formed of a material that permits buoyancy of the container, said container comprising:

a base portion;

a lid portion hingedly connected to said base portion wherein said lid portion is adapted for movement to allow access to the interior of the container; and

a releasably detachable strap having a connection means at each end thereof for releasable connection to said container, said strap having means to engage and retain said user in order to keep said user buoyant when said user is in a body of water such as the sea or a lake.

### BRIEF DESCRIPTION OF THE DRAWINGS

A preferred embodiment will hereinafter be described, by way of example only, with reference to the drawings wherein:

FIG. 1 is a side view of a retaining device attachable to a fishing accessory container such as a fishing tackle box;

FIG. 1a is a perspective view of the retaining device of FIG. 1;

FIG. 2 is an end view of the retaining device of FIG. 1;

FIG. 3 is a rear view of a fishing accessories container having attached thereto a pair of retaining devices together with an attachment that allows illumination means such as a torch to be secured to the lid of the container;

FIG. 4 is an end view of the fishing accessories container box of FIG. 3 showing the retaining device in a closed position;

FIG. 5 is an end view of the fishing accessories container of FIG. 3 but showing the retaining device in an open position;

FIG. 6 is a plan view of the fishing accessories container such as that shown in FIG. 3 but having the fishing rods retained by the respective retaining devices;

FIG. 7 is a front view of the fishing accessories container showing fishing rods and illumination device attached to the top of the container together with a shoulder strap which clips into respective connectors at the side of the container;

FIG. 8 is an end view similar to FIG. 5 but showing the illumination device actually clamped or retained within the retaining device;

FIG. 9 is a rear view of the fishing accessories container but showing the illumination device and at least one fishing rod attached to the lid of the accessories container;

FIG. 10 is a plan view showing the attachment of various sized fishing rods retained by the retaining devices on the lid of the container; and

FIG. 11 is a prospective view of the fishing accessories container have a detachable strap connected thereto at one end of the strap with the other end of the strap secured to a user.

### DETAILED DESCRIPTION OF PREFERRED EMBODIMENTS.

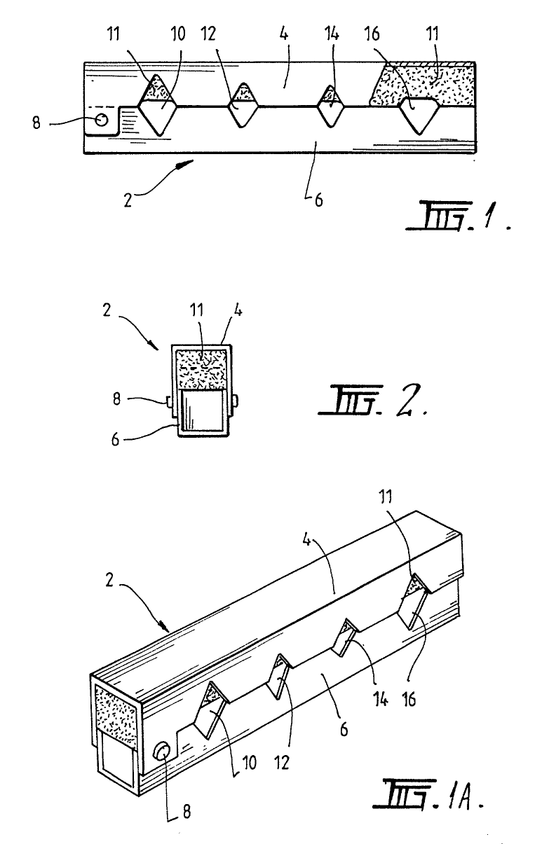

With reference to FIGS. 1, 1a and 2 there is shown a retaining device 2 for retaining fishing rods and other accessories, such as an illumination means, having a first member 4 and a second member 6. Each of the members 4 and 6 are joined at one end through a securing means, such as a pin 8 which is preferably made from stainless steel. The retaining means 2 has a number of recesses or apertures such as those indicated by numerals 10, 12, 14 and 16 which are of varying sizes in order to accommodate different widths of fishing rods and/or accessories. Each of the apertures extend across both members 4 and 6 so that when for example member 4 is raised to pivot about the pivot point through pin 8 various fishing rods may be inserted into the lower portion of each of the apertures located in member 6 and then member 4 is closed on top of the fishing rods so that the fishing rod is completely contained within the appropriately sized aperture. The members 4 and 6 are generally made from pressed stainless steel, and as can be seen from their profile in FIG. 2, may be in the form of generally U-shaped elongate brackets. Located within the upper portion of the apertures of the member 4, and throughout the interior of the member 4, or more specifically that portion of the apertures which is located in the member 4 has a material such as hardened foam which is designed to abut the periphery of the fishing rod so that it forms a snug fit within the apertures. After a number of uses the hardened foam will generally have memory like properties so that it remembers the corresponding shape of the fishing rod against which it abuts.

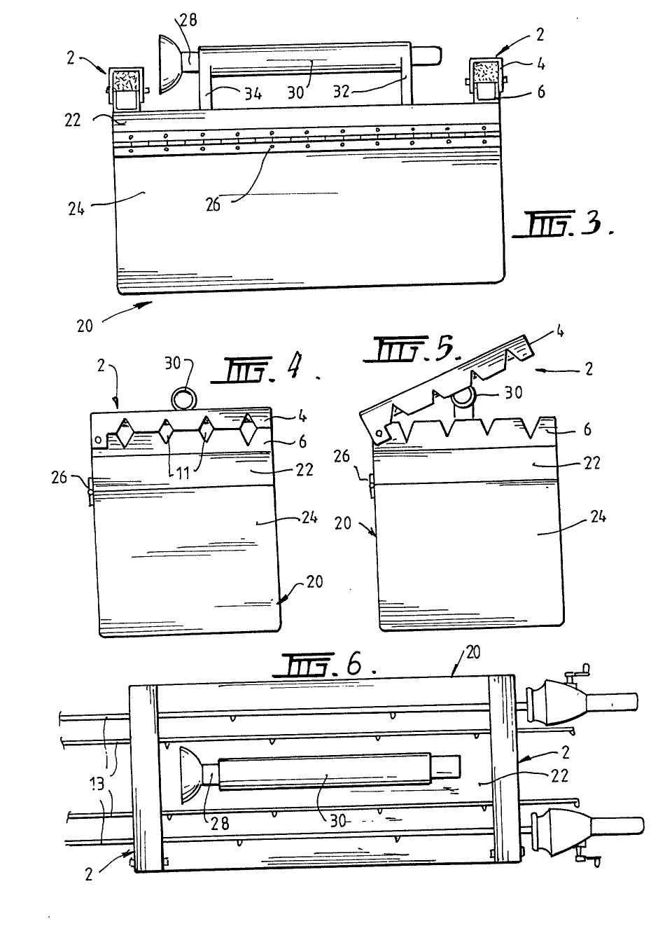

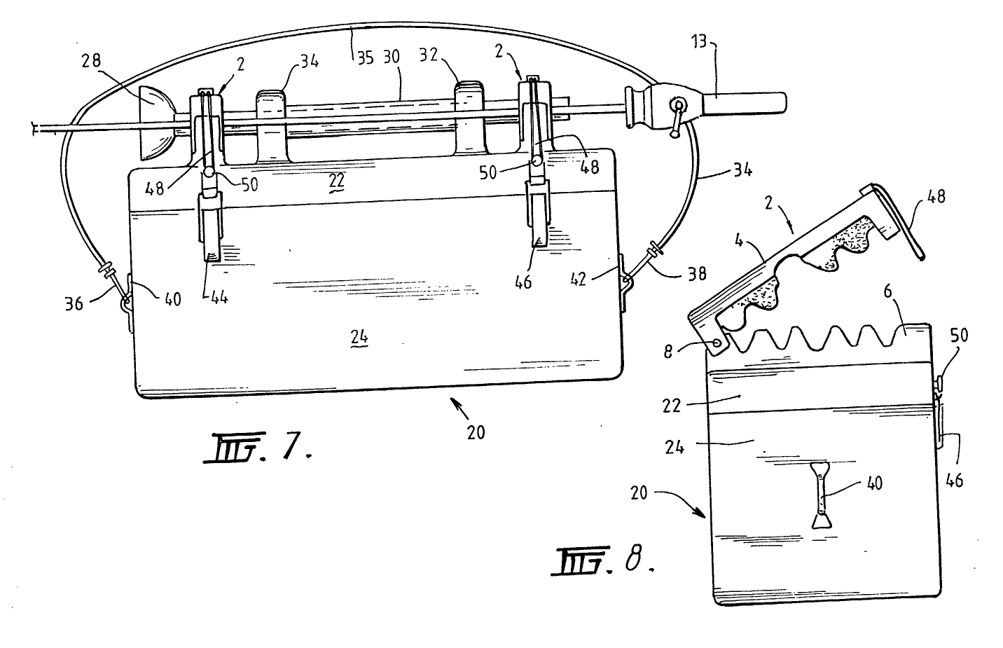

As mentioned previously the retaining means 2 is designed to fit or attach to a fishing accessory container such as a fishing tackle box 20 which is pictured in FIG. 3. The box is preferably made from plastics material, such as polyethylene, and manufactured using a rotationally molded method. The apparatus 2 may be secured to a top portion or lid 22 of the box 20 by way of any standard securing means which affixes the member 6 to the top surface of the lid 22. The lid 22 is attached to a bottom portion 24 by a standard hinge 26 which is generally made from stainless steel. An illumination means such as a torch 28 is designed to fit within a corresponding hollow substantially cylindrical member 30 which may be attached to the top portion or lid 22 of the box 20. It may be attached through brackets 32 and 34 or alternatively the torch 28 may have a corresponding aperture in the apparatus 2 which is specifically designed to fit around the circumference of the torch such as is shown in FIG. 8. The member 30 may be used as a handle to enable a user to easily carry the box 20 whilst the torch 28 is switched on for use in a dark environment.

Thus it can be seen from FIGS. 6 and 10 that any number of fishing rods may be attached to the box 20 by way of the apparatus 2 affixed at each end of the lid portion 22. The rods need not necessarily have their reels attached but may be disconnected so that portions of the rod may be affixed between the apertures in the apparatus 2. This makes it extremely convenient to carry the fishing accessories container with all of the accessories located therein and the rods 13 attached to the top portion of the lid 22. The member 30, which may be made from stainless steel, may alternatively be used as a handle when carrying the box 20.

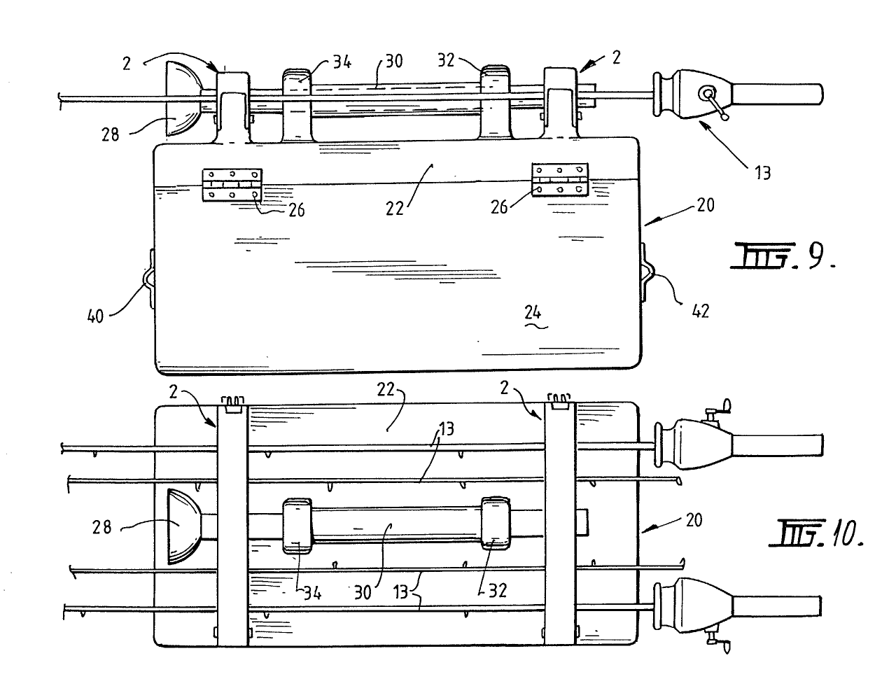

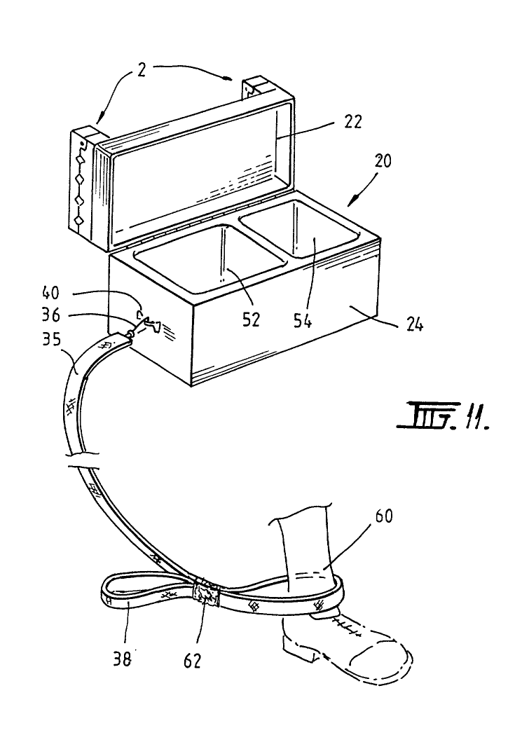

With reference to FIG. 7 there is shown a shoulder strap 35 which has respective clips 36 and 38 attached at either end of the strap 35 which clip into respective saddles 40 and 42, preferably made of stainless steel, attached to the side of the box 20 to securely retain the strap to the box. This aids in allowing a fishing person to conveniently carry the box 20 and still have one or two hands free. The front portion of the box has a pair of latches 44 and 46, also preferably made from stainless steel, to retain the lid 22 in a closed position against the base 24 of the box. Also attached at an outer end of the upper member 4 is securing means such as stretch loops 48, as seen in FIG. 8, that allow the closure of the upper member 4 against the lower member 6 of the retaining means 2 and this stretches over a projection or knob 50 located on the lid of the box 20.

With reference to FIG. 11 there is shown the box 20 in open condition and shown inside are various compartments 52 and 54 which may be used to house or store tackle or bait and other such items that a fishing person would need. The inside portion of the lid may also contain or house various other compartments for storage of other accessories. The shoulder strap 35 also doubles up as a device that may be attached from one end thereof to the ankle 60 (or wrist or other suitable part) of the user of the tackle box. Specifically a fastening means such as a hook and loop material such as velcro 62 may be used to secure the free end of the strap 35 around the ankle 60 and this is generally done before the fishing person sets up their fishing position off the cliffs or rocks or other areas close to water. The box 20 generally has included in its walls of the lid and base member 24 a lightweight polyethylene foam material filled in these portions so that it may be used as an esky for cooling the items such as fish bait and drinks and so forth but more importantly acts as a flotation device so that when or if a fishing person is swept off rocks in difficult weather the fishing box acts as a buoyancy device to keep the fishing person afloat or allow that person to grab onto the tackle box to stay afloat. This is where the device is useful in that the shoulder strap is able to be tied or secured around the ankle (or wrist) so that it does not drift away or separate from the user.

It will also be appreciated that various modifications and alterations may be made to the preferred embodiments above, without departing from the scope and spirit of the present invention.

The claims defining the invention are as follows:

1. A retaining device for attachment to a fishing accessories container, said retaining device adapted to releasably retain one or more fishing rods and/or other accessories, said retaining device comprising:
a pair of members pivotally attached at one end thereof, one member of said pair of members being attached to said container;
one or both of said members having a plurality of spaced apart recesses extending from one side to a further opposite side of said member of said pair of members;
wherein the other of said pair of members is configured for movement to create an opening between said pair of members so as to allow insertion into or removal from said plurality of recesses, said one or more fishing rods and/or accessories.

2. A retaining device according to claim 1 wherein said plurality of recesses are of varying dimensions so as to accommodate and retain said one or more fishing rods and/or said accessories that vary in dimensions.

3. A retaining device according to claim 1 or claim 2 wherein when each member of said pair of members has said plurality of recesses, each recess in each member coincides with a recess of similar dimensions in the other member when said members abut one another.

4. A retaining device according to any one of the previous claims wherein said other member in said pair of members has at a distal end to the pivot point a securing means for locking said other member to said container.

5. A retaining device according to claim 4 wherein said securing means is a flexible strap that engages a projection extending from said container in order to secure said other member to said container.

6. A retaining device according to claim 5 wherein in order to secure said one or more fishing rods and/or accessories, said user extends said other member to an open condition, places said one or more fishing rods and/or accessories in an appropriately dimensioned recess, said user then moves said other member towards said one member such that each one or more fishing rods and/or accessories are within said recess and securing said other member to said container by looping said flexible strap around said projection.

7. A retaining device according to any one of the previous claims wherein said other member is fitted with deformable material that contacts an accessory or fishing rod located in a recess so as to provide a close fit of said fishing rod or accessory within said recess.

8. A retaining device according to claim 7 wherein either or both of said members are substantially U-shaped elongate brackets.

9. A retaining device according to any one of the previous claims wherein said one member is secured to a lid of said container.

10. A fishing accessories container for storing accessories required by a user, said container comprising:
a base portion;
a lid portion hingedly connected to said base portion wherein said lid portion is adapted for movement to allow access to the interior of said container;
handle means constituted by a substantially hollow member adapted for carrying an illumination means;
such that when said illumination means is enabled or switched on it allows a user to easily see where they travel in dark conditions whilst carrying the container in one hand.

11. A fishing accessories container according to claim 10 wherein said substantially hollow member is cylindrical.

12. A fishing accessories container according to claim 10 or claim 11 wherein said illumination means is a torch.

13. A fishing accessories container according to any one of claims 10 to 12 further comprising strap means releasably detachable to said base portion of said container.

14. A fishing accessories container according to any one of claims 10 to 13 having the retaining device of any one of claims 1 to 9.

15. A fishing accessories container for storing accessories required by a user, said container being formed of a material that permits buoyancy of the container, said container comprising:
a base portion;
a lid portion hingedly connected to said base portion wherein said lid portion is adapted for movement to allow access to the interior of said container; and
a releasably detachable strap having a connection means at each end thereof for releasable connection to said container, said strap having means to engage and retain said user in order to keep said user buoyant when said user is in a body of water, such as the sea or a lake.

16. A fishing accessories container according to claim 15 wherein said engaging and retaining means is hook and loop fabric material located adjacent one end of said strap.

17. A fishing accessories container according to claim 16 wherein prior to fishing or undertaking an activity said user detaches said end of said strap from said container, loops said end around a part of their body such as an ankle or wrist, and fastens together said hook and loop fabric material so that the container is secured to said user, which container acts as a flotation device for situations where said user is in water and said container acts to keep said user afloat in said water.

18. A fishing accessories container according to any one of claims 15 to 17 further comprising handle means constituted by a substantially hollow member.

19. A fishing accessories container according to any one of claims 15 to 18 further comprising a retaining device claimed in any one of claims 1 to 9.

20. A retaining device substantially as hereinbefore described with reference to the accompanying drawings.

21. A fishing accessories container substantially as hereinbefore described with reference to the accompanying drawings.
